(19) United States
(12) Patent Application Publication
(10) Pub. No.: US 2025/0372106 A1
(43) Pub. Date: Dec. 4, 2025

(54) ENCODER FOR ENCODING A MULTI-CHANNEL AUDIO SIGNAL

(71) Applicant: FRAUNHOFER-GESELLSCHAFT ZUR FOERDERUNG DER ANGEWANDTEN FORSCHUNG E.V., Muenchen (DE)

(72) Inventors: Jan Frederik KIENE, Erlangen (DE); Eleni FOTOPOULOU, Erlangen (DE); Goran MARKOVIC, Erlangen (DE); Markus MULTRUS, Erlangen (DE); Guillaume FUCHS, Erlangen (DE)

(21) Appl. No.: 19/303,569

(22) Filed: Aug. 19, 2025

Related U.S. Application Data
(63) Continuation of application No. PCT/EP2024/054084, filed on Feb. 16, 2024.

(30) Foreign Application Priority Data
Feb. 21, 2023 (WO) PCT/EP2023/054334

(51) Int. Cl. G10L 19/008

(52) U.S. Cl. CPC G10L 19/008

(57) ABSTRACT

An audio encoder for a multichannel audio signal includes: a signal shaping unit to shape each channel using a number of scale parameters, configured to derive, for each channel, a number of scale parameters; a stereo processing unit to receive the shaped channels and provide a joint shaped audio signal from the shaped channels, a coded signal writer, to form a coded signal with at least the joint shaped audio signal; and a characteristic determiner to determine a characteristic from the channels having a characteristic state selected between a first characteristic state and a second characteristic state. The signal shaping unit is controlled by the characteristic determiner to derive: in the first characteristic state, the number of scale parameters using a channel-specific parameter for the channel; and in the second characteristic state, the number of scale parameters using a joint parameter derived from the first channel and the second channel.

### CROSS-REFERENCE TO RELATED APPLICATIONS

This application is a continuation of copending International Application No. PCT/EP2024/054084, filed Feb. 16, 2024, which is incorporated herein by reference in its entirety, and additionally claims priority from International Application No. PCT/EP2023/054334, filed Feb. 21, 2023, which is also incorporated herein by reference in its entirety.

### FIELD

The invention mainly regards an audio encoder, in particular having a spectral shaping and a stereo decision on a conversion of a multichannel signal into mid side channels.

### BACKGROUND

The invention relates, in some examples, to an encoder for encoding a multi-channel audio signal, thereby deciding whether to use the same spectral tilt for different channels or not. The invention also relates to signal-adaptive synchronization of spectral tilt used in whitening of stereo signals. The invention is also related to audio signal processing and can e.g. be applied in an MDCT-based stereo processing of e.g. Immersive Voice and Audio Services (IVAS) codec.

In the MDCT-stereo processing e.g. as described in [1] (e.g. FIG. 1), a system 100 includes a transform unit 102′, a preprocessing unit 105, a stereo processing unit 120, a stereo bandwidth extension stage 125 and an entropy coder 140 for encoding a multi-channel audio signal 102 onto a bitstream 142. There is used a single ILD parameter to normalize the Frequency-Domain Noise Shaped (FDNS) spectrum followed by the band-wise mid/side (M/S) vs left/right (L/R) decision (at 120) and the bitrate distribution among the band-wise M/S processed channels based on the energy is implemented. Processing steps are depicted in FIG. 1 and are described as followed:

Coding tools, such as Temporal Noise Shaping (TNS) 105 or estimation 115 of the Long-Term Prediction (LTP) gain 115′ are applied on the original left and right channels (L, R) separately.

Whitening/Normalization 110 of the signals using FDNS, is also done separately on the left and right channels.

Band-wise M/S stereo transform at 120 on the broadband ILD normalized whitened signals. M/S vs L/R decision at 120 is based on arithmetic coding bit consumption estimation.

Bitrate distribution at 120 is based on the energies of the signals after the stereo processing.

The FDNS stage 110 can be implemented e.g. using Linear-Predictive-Coding analysis (LPC) as used e.g. in [2] or e.g. using Spectral Noise Shaping (SNS) technique as described in [3]. SNS is a low-complexity alternative to the LCP-based noise shaping which computes the needed scalefactors for whitening the signal completely in the spectral domain. Scalefactors are interpolated from a smaller number of SNS parameters which are directly derived from the signal's power spectrum. In the computation of the parameters, a spectral tilt value is used to apply pre-emphasis on the signal. This tilt value is dependent on the sampling frequency of the signal which is the same in both channels of the stereo signal.

The spectral tilt used in SNS-based whitening can also be changed adaptively depending on the signal characteristic.

In [4], a mono signal coder is described using SNS with a signal-adaptive tilt controlled by the harmonicity of the signal. For harmonic signals (such as speech), a higher tilt is used to emphasize the lower frequencies more while for non-harmonic signals, the tilt is lowered. This way, lower frequencies are quantized with more detail for harmonic signals while the quantization step size is distributed more equally across the whole spectrum for spectrally flatter non-harmonic signals like transients which can be perceptually more efficiently coded this way.

Using the adaptive tilt in SNS adapts the noise shaping pre-emphasis based on the current signal characteristics to allow perceptually efficient quantization of the spectrum for both harmonic and non-harmonic signals. Adding this technique to a stereo coder such as MDCT-Stereo could in principle be trivially done by simply deriving harmonicity measures for both channels and applying them in the respective channel's FDNS stage. This would aim at generating harmonicity measure values optimally fitted to each channel, without considering the latter stereo processing. In general, the derived harmonicity measure values differ between the channels (except for the trivial case of both channels containing the same signal), thus the FDNS stages of both channels in general apply different pre-emphasis on the respective channel signals resulting in different spectral envelopes being used in the whitening of the signals. A bigger difference in the used spectral envelopes can be problematic for the later stereo processing as the different whitening can lead to decreased energy compaction by the M/S transform. This is not an issue if the stereo channels are in general uncorrelated, since it is expected that they would be coded individually (no M/S transform). However, this can also occur for more correlated signals due to various reasons e.g. background noise or imperfections in the harmonicity measure estimation process. For highly correlated signals, an M/S transform for the majority or all the stereo bands is to be expected and using too different spectral tilts is undesirable.

A naïve solution to address this issue, would be to use L/R (individual) coding for these cases, but for panned correlated signals this is usually suboptimal and leads to different kinds of artifacts such as stereo unmasking and generally higher quantization noise levels which usually greatly degrade the perceptual quality. Another option would be to use the same spectral tilt, but this would limit the ability of the coder to adapt its noise shaping operation as good as possible to the signal characteristics. Especially for situations with very different signals in the two channels (e.g. hard-panned signals) with possibly quite different harmonicity values this is not optimal.

FIG. 2 shows a simplified stereo coder 200 according to conventional technology, converting a multi channel signal 102 from spatial channels onto joint channels 222, according to a stereo decision performed at stereo processing block 220. Here, there are shown a LTP parameter calculation block 215 for performing a long term prediction (e.g. in TD) on the signal 102; a TD-FD converter 223 (here shown as converting the TD signal using the MDCT); and a FDNS stage 210 for shaping the signal outputted by the TD-FD converter 223 using parameters gl and gr received from the LTP parameter calculation block 215, to whiten the signal. The stereo processing at 220 is applied in the whitened domain. It can be functionally corresponding to the MDCT-Stereo system 100 shown in FIG. 1 with the addition of signal-adaptive tilt. The tilt is only used in FDNS operation which is already finished before the stereo processing. Some pre-processing tools and the quantization and bitstream writing steps are omitted in FIG. 2 for simplicity. The stereo processing block 220 includes the same stereo processing—global ILD compensation, band-wise M/S decision at 220 and bitrate distribution based on energy—as in [1].

The LTP parameter calculation block 215 in FIG. 2 operates like the LTP unit 115 in FIG. 1 and serves the same purpose as the LTP filter used in EVS [2]. It does not alter the signal but calculates a gain (gl, gr) for the TCX-LTP filter which is quantized and sent in the bitstream (not shown in diagram). Parameters gl and gr in the diagram denote the unquantized version of these gains calculated for the left and right channel, respectively. The MDCT block 223 transforms the signal from the time domain to the frequency domain using the MDCT. Afterwards, frequency domain noise shaping (FDNS) using SNS [3] at block 210 is applied to obtain a whitened version of the channel signals. The FDNS block 210 includes both calculation of the SNS parameters and actual whitening of the signals. In the SNS parameter calculation, a spectral tilt is applied which is calculated from a constant value that was tuned for different signal bandwidths. This value is then multiplied by the unquantized LTP filter gain of the respective channel, thus achieving the signal-adaptive tilt.

### SUMMARY

According to an embodiment, an audio encoder for encoding a multichannel audio signal into a coded signal, the multichannel audio signal having a plurality of channels including a first channel and a second channel, may have: a signal shaping unit configured to shape each channel of the plurality of channels using one or more scale parameters to obtain shaped channels, the signal shaping unit being configured to derive, for each channel of the plurality of channels, of the one or more scale parameters; a stereo processing unit configured to receive the shaped channels and to provide a joint shaped audio signal from the shaped channels, a coded signal writer, configured to form a coded signal with at least the joint shaped audio signal; and a characteristic determiner configured to determine a characteristic from the plurality of channels having a characteristic state selected between at least one first characteristic state and one second characteristic state, the first characteristic state being different from the second characteristic state, wherein the signal shaping unit is configured to be controlled by the characteristic determiner and to derive: in the first characteristic state, for each channel of the plurality of channels, the one or more scale parameters using a channel-specific parameter for the channel; and in the second characteristic state, for each channel of the plurality of channels, the one or more scale parameters using a joint parameter derived from the first channel and the second channel.

Another embodiment may have a non-transitory storage unit storing instructions which, when executed by a processor, cause the processor to perform the following method for encoding a multichannel audio signal into a coded signal, the multichannel audio signal having a plurality of channels including a first channel and a second channel, the method having the steps of: shaping each channel of the plurality of channels using one or more scale parameters to obtain shaped channels, the shaping including deriving, for each channel of the plurality of channels, the one or more scale parameters; performing a stereo processing, the stereo processing including providing a joint shaped audio signal from the shaped channels, forming a coded signal with at least the joint shaped audio signal; and determining a characteristic from the plurality of channels having at least one of a first characteristic state and a second characteristic state, the first characteristic state being different from the second characteristic state, wherein the shaping is controlled by the characteristic to derive: in the first characteristic state, for each channel of the plurality of channels, the one or more scale parameters using a channel-specific parameter for the channel; and in the second characteristic state, for each channel of the plurality of channels, the one or more scale parameters using a joint parameter derived from the first channel and the second channel.

In accordance to an aspect, there is provided an audio encoder for encoding a multichannel audio signal into a coded signal, the multichannel audio signal having a plurality of channels including a first channel and a second channel, the audio encoder comprising: a signal shaping unit configured to shape each channel of the plurality of channels using a number of scale parameters to obtain shaped channels, the signal shaping unit being configured to derive, for each channel of the plurality of channels, a number of scale parameters; a stereo processing unit configured to receive the shaped channels and to provide a joint shaped audio signal from the shaped channels, a coded signal writer, configured to form a coded signal with at least the joint shaped audio signal; and a characteristic determiner configured to determine a characteristic from the plurality of channels having a characteristic state selected between at least one first characteristic state and one second characteristic state, the first characteristic state being different from the second characteristic state, wherein the signal shaping unit is configured to be controlled by the characteristic determiner and to derive: in the first characteristic state, for each channel of the plurality of channels, the number of scale parameters using a channel-specific parameter for the channel; and in the second characteristic state, for each channel of the plurality of channels, the number of scale parameters using a joint parameter derived from the first channel and the second channel.

In accordance to an aspect, there is provided an audio encoder for encoding a multichannel audio signal into a coded signal, the multichannel audio signal having a plurality of channels including a first channel and a second channel, the audio encoder comprising: a signal shaping unit configured to shape each channel of the plurality of channels using a number of scale parameters to obtain shaped channels, the signal shaping unit being configured to derive, for each channel of the plurality of channels, a number of scale parameters; a stereo processing unit configured to receive the shaped channels and to provide a joint shaped audio signal from the shaped channels, a coded signal writer, configured to form a coded signal with at least the joint shaped audio signal; and a characteristic determiner configured to determine a characteristic from the plurality of channels having at least one of a first characteristic state and a second characteristic state, the first characteristic state being different from the second characteristic state, wherein the signal shaping unit is configured to be controlled by the characteristic determiner and to derive: in the first characteristic state, for each channel of the plurality of channels, the number of scale parameters using a channel-specific parameter for the channel; and in the second characteristic state, for each channel of the plurality of channels, the number of scale parameters using a joint parameter derived from the first channel and the second channel.

According to an aspect, the signal shaping unit is configured to use, as the channel-specific parameter, a harmonicity measure for the specific channel or a measure derived from the harmonicity measure, and/or derive the joint parameter from harmonicity measures of the channels.

According to an aspect, the signal shaping unit is configured to use, as the channel-specific parameter, a LTP parameter of the channel or a measure derived from the LTP parameter, and/or derive the joint parameter from long term prediction, LTP, parameters of the channels.

According to an aspect, the signal shaping unit is configured to use, as the channel-specific parameter, a quantized channel-specific parameter, or a measure derived from the quantized channel-specific parameter and/or derive the joint parameter from a quantized channel-specific parameters.

According to an aspect, the signal shaping unit is configured to use, as the channel-specific parameter, a normalized channel-specific parameter, or a measure derived from the normalized channel-specific parameter, and/or derive the joint parameter from normalized channel-specific parameters.

According to an aspect, the signal shaping unit is configured to use, as the channel-specific parameter, a spectral flatness measure computed for the respective channel, or a measure derived from the spectral flatness measure computed for the respective channel, and/or derive the joint parameter from spectral flatness measures computed for the channels.

According to an aspect, in the first characteristic state the signal shaping unit is configured to apply, for each channel, the channel-specific parameter to control a pre-emphasize tilt applied to channel-specific energy(ies) per band, to thereby derive pre-emphasized channel specific energy(ies) per band from which the number of scale parameters are derived, and/or in the second characteristic state the signal shaping unit is configured to apply the joint parameter to all the channels, to control the pre-emphasize tilt applied to channel-specific energy(ies) per band, to thereby derive pre-emphasized channel specific energy(ies) per band from which the scale parameters are derived.

According to an aspect, the audio encoder is configured to calculate the pre-emphasize tilt for the first and second channels by, for each band: first, calculating a common term, common to both channel then: in case of first characteristic state, for each channel scaling the common term by the channel-specific parameter; in case of second characteristic state, for both channels scaling the common term by the joint parameter.

According to an aspect, the audio encoder is configured so that a comparatively higher channel-specific parameter causes a higher pre-emphasize tilt to be applied to the channel specific energy(ies) per band, than a comparatively lower channel-specific parameter, and/or a comparatively higher joint parameter causes a higher pre-emphasize tilt to be applied to the channel specific energy(ies) per band, than a comparatively lower joint parameter.

The audio encoder of any of the preceding aspects, wherein, in the first characteristic state, the channel-specific energy, for each band, verifies

$${E}_{p} ( b ) = {E}_{s} ( b ) \cdot {d}^{( \frac{b \cdot {g}_{tilt} \cdot {g}_{l , r}^{′}}{h \cdot nb} )} ,$$

where

$$\frac{b \cdot {g}_{tilt} \cdot {g}_{l , r}^{′}}{h \cdot nb}$$

is an exponent applied to d>1, h>0 is fixed,

$${g}_{l , r}^{′} \geq 0$$

is, or is derived from, the channel-specific parameter, gₜᵢₗₜ>0 is pre-defined, b is an index indicating the band out of nb bands.

According to an aspect, the channel-specific parameter is the same for all, or a plurality of, the bands of the same channel, and/or the joint parameter is the same for all, or a plurality of, the bands of the same channel.

According to an aspect, the audio encoder is configured to use the joint parameter as, or as defined based on, an average, or at least one an intermediate value, between channel-specific parameters of the channels.

According to an aspect, the audio encoder is configured to use the joint parameter as, or as defined based on, an integral value, or an information on the integral value, between specific parameters of the channels, or values indicative of the channel-specific parameters of the channels, or values derived from the specific parameters of the channels.

According to an aspect, the audio encoder is configured to use the joint parameter by weighting the specific parameters of the channels by applying a first weight to the channel-specific parameter of the first channel and a second weight to the channel-specific parameter of the second channel, the first and second weights being proportional to the energy of the first and second channel, respectively.

According to an aspect in the second characteristic state, the channel-specific energy, for each band, and for each channel, verifies

$${E}_{p} ( b ) = {E}_{s} ( b ) \cdot {d}^{( \frac{b \cdot {g}_{tilt} \cdot {g}_{l , r}^{′}}{h \cdot nb} )} ,$$

where

$$\frac{b \cdot {g}_{tilt} \cdot {g}_{l , r}^{′}}{h \cdot nb}$$

is an exponent applied to d>0 (e.g. d>1), h>0 is fixed,

$${g}_{l , r}^{′}$$

is the joint parameter, and b is, or is derived from, an index indicating the band out of nb bands.

According to an aspect, the audio encoder is configured to use the characteristic as, or as determined from, a coherence between the plurality of channels, wherein comparatively higher coherence values cause the characteristic to be in the second characteristic state, and comparatively lower coherence values cause the characteristic to be in the first characteristic state.

According to an aspect, the audio encoder is configured to use the characteristic as, or as determined from, a correlation between the plurality of channels, wherein comparatively higher correlation values cause the characteristic to be in the second characteristic state, and comparatively lower correlation values cause the characteristic to be in the first characteristic state.

According to an aspect, the audio encoder is configured to use the characteristic as, or as determined from, a covariance between the plurality of channels, wherein comparatively higher covariance values cause the characteristic to be in the second characteristic state, and comparatively lower covariance values cause the characteristic to be in the first characteristic state.

According to an aspect, the audio encoder is configured to use the characteristic as, or as determined from, a similitude degree between the plurality of channels, wherein comparatively higher similitude values cause the characteristic to be in the second characteristic state, and comparatively lower similitude values cause the characteristic to be in the first characteristic state.

According to an aspect, the stereo processing unit is configured to decide band-wise between: converting the plurality of shaped channels onto a mid channel and a side channel, the mid channel and the side channel thereby constituting the joint channels; and defining the joint channels as the plurality of shaped channels.

According to an aspect, the stereo processing unit is configured to decide between converting the shaped audio signal from the plurality of shaped channels onto a mid channel and a side channel and defining the joint channels as the plurality of channels based, at least in part, on a minimization of bitrate demand.

According to an aspect, the stereo processing unit is configured to decide between converting the shaped audio signal from the plurality of shaped channels onto a mid channel and a side channel and defining the joint channels as the plurality of channels based, at least in part, on energy distribution between joint channels.

According to an aspect, the stereo processing unit is configured to decide between converting the shaped audio signal from the plurality of shaped channels onto a mid channel and a side channel and defining the joint channels as the plurality of channels based, at least in part, on a measure of cross-correlation between the shaped channels.

According to an aspect, the stereo processing unit is configured to decide between converting the shaped audio signal from the plurality of shaped channels onto a mid channel and a side channel and defining the joint channels as the plurality of channels based, at least in part, on a measure of coherence or similitude between the shaped channels.

According to an aspect, the audio encoder is configured to use the characteristic as, or as determined from, a number of bands for which the stereo processing unit has decided to convert the shaped audio signal from the plurality of channels onto a mid channel and a side channel in at least one preceding frame, in such a way that, in case the number of bands for which it has been decided to convert the shaped audio signal from the plurality of channels onto a mid channel and a side channel is over a predetermined threshold, the characteristic is in the second characteristic state, otherwise the characteristic is in the first characteristic state.

According to an aspect, the audio encoder is configured to use the characteristic as, or as determined from, the number of bands for which the stereo processing unit has decided to convert the shaped audio signal from the plurality of channels onto a mid channel and a side channel in at least one preceding frame, in respect to the totality of the plurality of channels.

According to an aspect, the audio encoder is configured to use the characteristic as, or as determined from, the number of bands for which the stereo processing unit has decided to convert the shaped audio signal from the plurality of channels onto a mid channel and a side channel in at least one preceding frame, in respect to a restricted plurality of channels selected among the plurality of channels.

According to an aspect, the audio encoder is configured to use the predetermined threshold as being more than 50% of the total number of bands or the number of the restricted plurality of channels.

According to an aspect, the audio encoder is configured to use the predetermined threshold as being between 70% and 90% of the total number of bands or the number of the restricted plurality of channels.

According to an aspect, the audio encoder is configured to use, as the at least one preceding frame, the immediately preceding frame.

According to an aspect, the audio encoder is configured to transform the channels from time domain to frequency domain, wherein the signal shaping unit is configured to shape the channel in the frequency domain.

According to an aspect, the audio encoder is configured to determine the characteristic from a time domain version of the channels.

According to an aspect, the coded signal writer is configured to insert, in the coded signal, the information on the characteristic and/or the channel-specific parameter and/or the joint parameter.

According to an aspect, the audio encoder further comprises a long term prediction, LTP, unit to obtain an LTP gain, further configured to use the LTP gain as, or for obtaining, the signal-specific parameter and/or the joint parameter.

According to an aspect, the audio encoder further comprises a long term prediction, LTP, unit to obtain an LTP gain which includes a pitch search, further configured to use the normalized autocorrelation value for the pitch value found by the pitch search as, or for obtaining, the signal-specific parameter or joint parameter.

According to an aspect, the signal shaping unit is configured to spectrally tilt the audio signal according to shaping parameters obtained by applying, for each channel, a pre-emphasize tilt to energy(ies) of band(s) in reason of channel-specific parameters, wherein the channel-specific parameters are channel specific for the plurality of channels in the first characteristic state, and equal in the second characteristic state.

According to an aspect, the characteristic is indicative of a degree of similarity between the plurality of channels.

According to an aspect, the audio encoder is configured to apply to apply the channel-specific parameter as a parameter which is 1, or another constant value B>0, in case of a channel being totally harmonic, and 0 in case of a channel being totally non-harmonic, and configured to apply the joint parameter as a parameter which is an average and/or integral value, and/or an intermediate value between two channel-specific parameters, each of the two channel-specific parameters being 1, or another constant value B>0, in case of the channel being totally harmonic, and 0 in case of the channel being totally non-harmonic.

According to an aspect, the signal shaping unit is configured to apply, in the first characteristic state, a higher pre-emphasize tilt in case of higher harmonicity, and a lower-pre-emphasis tilt in case of lower harmonicity and, in case of second characteristic state, a higher pre-emphasize tilt in case of higher average between, or integral value of, the harmonicities, and a lower-pre-emphasis tilt in case of lower average between, or integral value of, the harmonicities.

In accordance to an aspect, there is provided a method for encoding a multichannel audio signal into a coded signal, the multichannel audio signal having a plurality of channels including a first channel and a second channel, the method comprising: shaping each channel of the plurality of channels using a number of scale parameters to obtain shaped channels, the shaping including deriving, for each channel of the plurality of channels, a number of scale parameters; performing a stereo processing, the stereo processing including providing a joint shaped audio signal from the shaped channels, forming a coded signal with at least the joint shaped audio signal; and determining a characteristic from the plurality of channels having at least one of a first characteristic state and a second characteristic state, the first characteristic state being different from the second characteristic state, wherein the shaping is controlled by the characteristic to derive: in the first characteristic state, for each channel of the plurality of channels, the number of scale parameters using a channel-specific parameter for the channel; and in the second characteristic state, for each channel of the plurality of channels, the number of scale parameters using a joint parameter derived from the first channel and the second channel.

In accordance to an aspect, there is provided a non-transitory storage unit storing instructions which, when executed by a processor, cause the processor to perform the method of the previous aspect.

### BRIEF DESCRIPTIONS OF THE DRAWINGS

Embodiments of the present invention will be detailed subsequently referring to the appended drawings, in which:

FIGS. 1 and 2 show encoders according to conventional technology.

FIGS. 3-6 show encoders according to the present solutions.

### DETAILED DESCRIPTION

### EXAMPLES

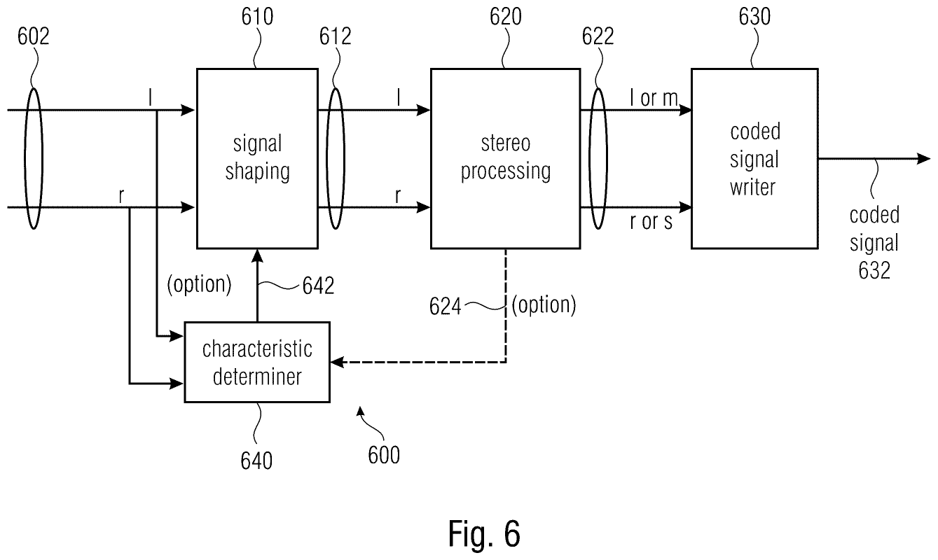

FIG. 6 shows an example of an audio encoder 600 according to the present techniques. Other examples of these audio encoders will be specified in detail below.

The audio encoder 600 may encode a multi-channel audio signal 602 into an coded signal 632. In a general example, any of the multi-channel audio signals and the encoding signal 632 may be in any domain (e.g., time domain, frequency domain, etc.) and in any dimension. In general terms, encoded signal 632 may be understood as a compressed version of the multi-channel audio system signal 602. In some cases, at least one or both of the multi-channel audio signal 602 and decoder signal 632 are binaural.

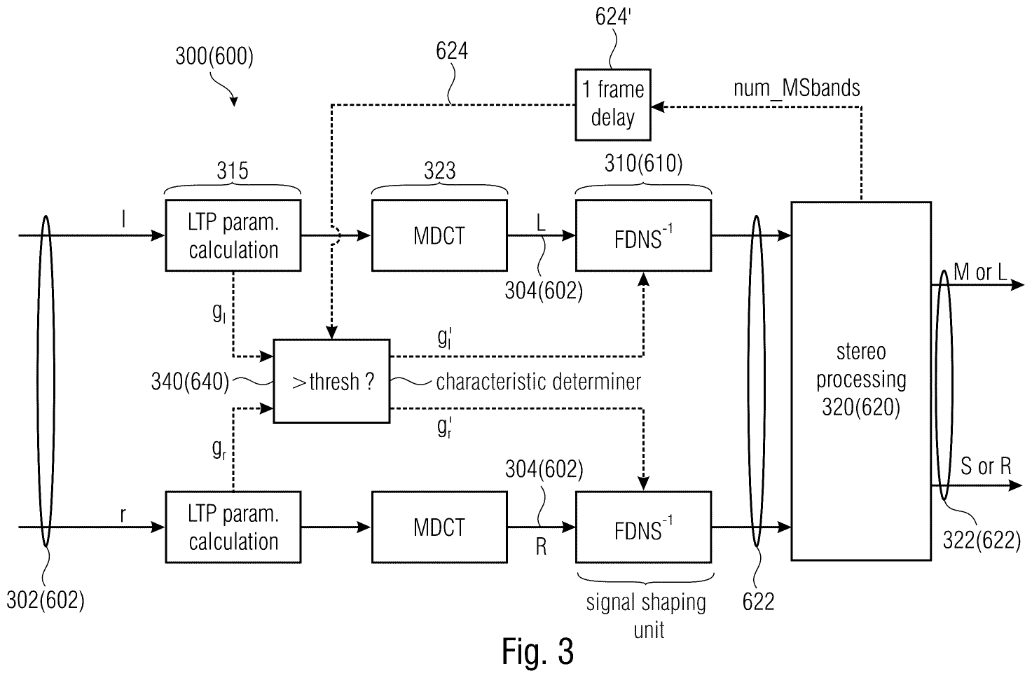

A signal shaping unit 610 may shape each channel of the channels of the multi-channel audio signal 602. The signal shaping unit 610 may make use, for example, of a number of scale parameters (the number of scale parameters may be a fixed number, it may be 1, it may be a plurality of numbers, e.g., n channels). The scale parameters may be for example, shaping parameters (e.g. signal noise shaping parameters, etc.). The scale parameters may be, for example, whitening parameters. The scale parameters may be, for example, FDNS parameters or SNS parameters. The audio signal 602 may therefore be conditioned by the signal shaping, and its shaped version 612 may present a whitened spectrum in respect to the original version 602. It is to be noted that (despite not being explicitly shown in FIGS. 6 and 3-5) often also the scale parameters are encoded in the coded signal, so that a decoder is capable of reconstructing an audio signal which is a reproduction of the signal 602.

In general terms, the channels of the signal 602 (or its shaped version 612) may be in the frequency domain. In the frequency domain the signal may have, for example, a first channel which may be a left (L) channel and a second channel which may be a right (R) channel. In general, channels, when considered collectively, may also be indicated with the same reference numeral of the signal (e.g. instead of “channels l and r” or “channels L and R” it may be used “channels 602”, for example or another reference numeral indicating a processed version of the signal), for brevity and conciseness.

The audio encoder 600 may include a stereo processing unit 620. The stereo processing unit 620 may receive the shaped channels 612 of the audio signal 602. The stereo processing unit 620 may provide (e.g., as an output) a joint shaped audio signal 622 from the shaped channels 612. The joint shaped audio signal 622 may comprise, for example, the shaped channels 612 which may be the same L/R shaped channels of the version 612. In alternative, following a decision of the stereo processing unit 620, the stereo processing unit 620 may provide, as joint channels 622, channels converted in the mid-side domain, i.e., comprising a mid-channel (M) and a side channel (S). Therefore, the stereo processing unit 620 may decide whether to convert the shaped channels 612 or not. The stereo processing unit 620 may base the stereo decision on the minimization of bitrate demand. In additional alternatives, the stereo decision may be based on the energy distribution between joint channels 622. In an additional alternative, the stereo decision may be based on a measure of cross-correlation between the shaped channels 612. The stereo decision (and the consequent conversion from L/R to M/S or not), may be bandwise, i.e. for each band there may be a decision on whether to conversion from L/R to M/S or not.

The audio encoder 600 may have a coded signal writer (e.g. bitstream writer) 630. The coded signal writer 630 may form a coded signal 632 with at least the joint shaped audio signal 622. In case, there can be parameters, such as the scale parameters (the coded audio signal 622 may therefore comprise a transport channel and parameters, e.g. the scale parameters, as side information). The coded signal 622 may be (or may be part of) a bitstream.

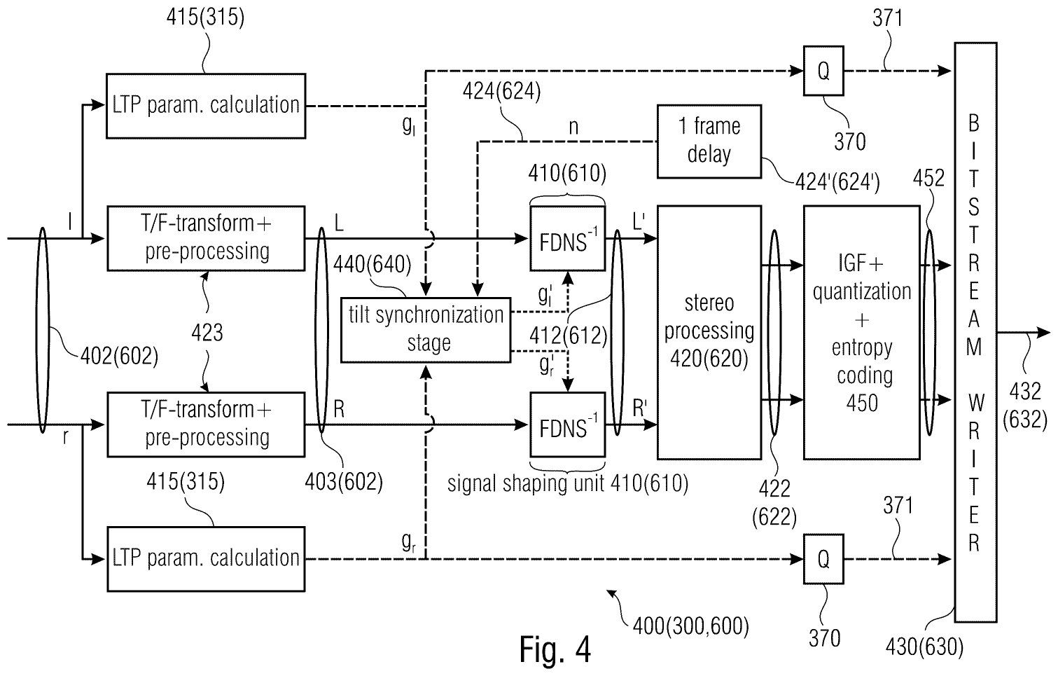

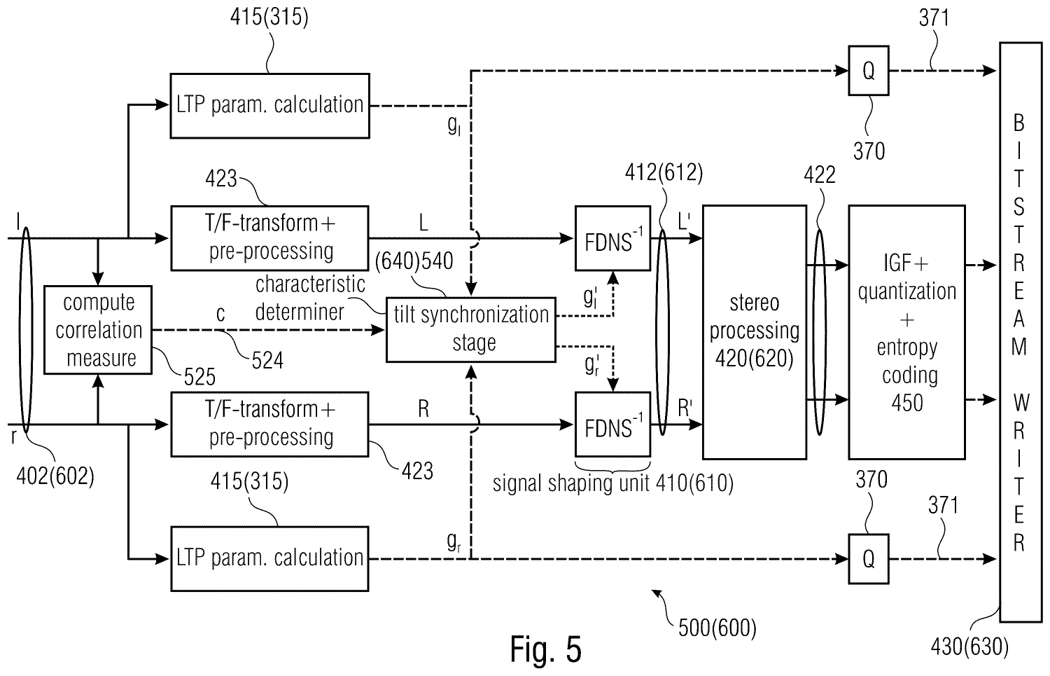

The coded signal writer (e.g. bitstream writer) 630 may include, for example a quantizer for quantizing the shaped signal 622 (or a processed version thereof) before it is actually written in the coded signal (bitstream) 622. The coded signal writer (e.g. bitstream writer) 630 may include, for example, at least one of a quantizer, an IGF (intelligent gap filling) unit, and an entropy coder. In some representations of the present examples (e.g. in FIGS. 4 and 5) the at least one of a quantizer, an IGF unit, and an entropy coder is represented with one single block 450 and is represented as being external to the coded signal writer (e.g. bitstream writer) 630 for simplicity.

The audio encoder 600 may comprise a characteristic determiner (which, in some examples, is embodied by a “tilt synchronization stage”) 640. The characteristic determiner 640 may determine a characteristic 642 from the plurality of channels (e.g., in their version of signal 602 or 612). The characteristic 642 may have at least one of a first characteristic state and a second characteristic state, the first characteristic state being different from the second characteristic state. The characteristic state of the characteristic may therefore be selected, by the characteristic determiner 640, between at least the first characteristic state and the second characteristic state. In examples, the selection may be between only two characteristic states. In other examples, there may be more than two characteristic states. The characteristic states may be disjointed from each other. The second characteristic state may be associated, for example, to a comparatively higher coherence, between the channels of the multichannel audio signal, than in the first characteristic state. The second characteristic state may be associated, in addition or alternative, to a comparatively higher correlation, between the channels of the multichannel audio signal, than in the first characteristic state. The second characteristic state may be associated, in addition or alternative, to a comparatively higher covariance, between the channels of the multichannel audio signal, than in the first characteristic state. The second characteristic state may be associated, in addition or alternative, to a comparatively higher similitude, between the channels of the multichannel audio signal, than in the first characteristic state. In general terms, the second characteristic state indicates that the channels are tendentially similar (coherent, correlated, covariant, etc.), while the second characteristic state indicates that the channels are tendentially different (incoherent, uncorrelated, non-covariant, etc.).

The characteristic determiner 640 may choose the signal characteristic 642 based on comparing at least one coherence value (or correlation value, or covariance value, or similitude value) with at least one respective threshold (which may be, respectively, a coherence threshold, a correlation threshold, a covariance threshold, or a threshold). Accordingly, the characteristic determiner 640 may choose the second characteristic state in case the coherence value (or correlation value, or covariance value, or more in general similitude value) is above the threshold (thereby indicating a higher similitude), and the first characteristic state in case the at least one coherence value (or correlation value, or covariance value, or similitude value) is below the respective threshold. The threshold may be understood as discriminating between a low coherence, covariance, correlation, similitude, etc. in case of coherence value, covariance value, correlation value, similitude value below the threshold (thereby implying the selection of the first characteristic state), and a high coherence, covariance, correlation, similitude, etc. in case of coherence value, covariance value, correlation value, similitude value being above the threshold (thereby implying the selection of the second characteristic state). In some cases, the characteristic determiner 640 may base its decision, at least partially, on the time domain version of the signal 602. In some cases, the characteristic determiner 640 may base its decision, at least partially, on the results of the stereo processing (e.g. for a previous frame).

It will be shown (e.g. in FIGS. 3-5) that the decision performed by the characteristic determiner 640 may be in the form of providing a particular parameter (e.g.,. joint parameter and/or channel-specific parameters) to the signal shaping unit 610.

It is to be noted that the stereo decision (at the stereo processing unit 620) may be performed band-by-band (e.g., for one first band there may be chosen the stereo conversion, while for another band of the same frame there may be chosen to skip the step conversion), the determination of the signal characteristic 642 (at the characteristic determiner 640) may be performed for a plurality of bands (e.g. for all the bands of the same frame, or of a plurality of consecutive frames). Therefore, the signal characteristic 642 may be globally valid, for example, for all (or at least for a plurality of) bands of the same frame. Therefore, in examples the signal characteristic (and the consequent classification between the first characteristic state and the second characteristic state) is determined once for each frame. Hence, the characteristic is in general globally valid for all the bands, in one frame.

The signal shaping unit 610 may be configured to be controlled by the characteristic determiner 640 (and in particular, by the current information on the characteristic 642) and to derive: in the first characteristic state (e.g. measured or expected low correlation, low coherence, low covariance, and/or low similitude between the channels, lower number of bands subjected to conversion into M/S channels), for each channel, the signal shaping unit 610 uses a channel-specific parameter (e.g., for the left channel the scale parameter(s) being obtained from metrics specific of the left channel, e.g. while for the right channel the scale parameter(s) being, or being derived from, metrics specific of the right channel, e.g. alone); in the second characteristic state (e.g. measured or expected high correlation, high coherence, high covariance, and/or high similitude between the channels, high number of bands subjected to conversion into M/S channels), for all channel, the signal shaping unit 610 uses a joint parameter being, or being derived from, the first channel and the second channel (e.g. “synchronization”).

It will be shown, in particular, that, for example, in case of second characteristic state (e.g. measured or expected high correlation, high coherence, high covariance, and/or high similitude between the channels, high number of bands subjected to conversion into M/S channels) the scale parameters may be obtained by applying the same spectral tilt to the different channels. In case of the first characteristic state (e.g. measured or expected low correlation, low coherence, low covariance, and/or low similitude between the channels, lower number of bands subjected to conversion into M/S channels), the scale parameters may be obtained by applying different spectral tilts (i.e. one first spectral tilt for the first channel and one second spectral tilt for the second channel, the first spectral tilt being derived from channel-specific parameter(s) of the first channel, and the second spectral tilt being derived from channel-specific parameter(s) of the second channel).

In addition or alternative, the signal shaping unit 610 may use: as the channel-specific parameter in case of the first characteristic state (e.g. measured or expected low correlation, etc.), for each channel, a long term prediction (LTP) parameter (e.g. LTP gain and/or cross correlation, e.g. normalized cross correlation) of the same channel; and/or as joint parameter in case of the second characteristic state (e.g. measured or expected high correlation, etc.), a common (joint) parameter for all the channels, the common (joint) parameter being, or being derived from, (e.g. by average between, or more in general by linear combination between, or a value intermediate between) the long term prediction (LTP) parameters (e.g. LTP gains and/or cross correlations, e.g. normalized cross correlations) of both the channels; (the LTP parameters for the first characteristic state and/or for the second characteristic state may be quantized, in examples, while in other examples they may be quantized); (the LTP parameters for the first characteristic state and/or for the second characteristic state may be normalized, while in other examples they may be non-normalized).

In addition or alternative, the signal shaping unit 610 may use: as the channel-specific parameter in case of the first characteristic state (e.g. measured or expected low correlation, etc.), for each channel, a quantized channel-specific parameter (e.g. it could be the same of that written in the coded signal 632, for example) (the channel-specific parameter may be, for example, a quantized LTP parameter, and/or quantized whitening parameter, and/or quantized FDNS parameter, for that specific channel); and/or as joint parameter in case of the second characteristic state (e.g. measured or expected high correlation, etc.), a common (joint) parameter for all the channels, the common (joint) parameter being, or being derived from, the quantized channel-specific parameters of the channels (e.g. those quantized channel-specific parameters written in the coded signal 632) (the joint parameter could be, for example, an average, or more in general a linear combination, of the quantized channel-specific parameters, or or a value intermediate between the channel-specific parameters) (the quantized channel-specific parameters may be, for example, a quantized LTP parameter, or a quantized whitening parameter, or quantized FDNS parameter) (the quantized channel-specific parameters may be, for example, quantized LTP parameters, or quantized whitening parameters, or quantized FDNS parameters, e.g. averaged with each other among the different channels, or more in general linearly combined with each other among the different channels) (the quantized parameters for the first characteristic state and/or for the second characteristic state may be normalized or, in other examples, non-normalized).

In addition or alternative, the signal shaping unit 610 may use: as the channel-specific parameter in case of the first characteristic state (e.g. measured or expected low correlation, etc.), for each channel, a spectral flatness measure, or a value derived from (or indicating) the spectral flatness measure; and/or as joint parameter in case of the second characteristic state (e.g. measured or expected high correlation, etc.), a common (joint) parameter derived from spectral flatness measures computed for the two channel (the joint parameter could be, for example, an average, or more in general a linear combination between, or a value intermediate between, the spectral flatness measures, or of information derived from the spectral flatness measures).

More in general, the signal shaping unit 610 may use: as the channel-specific parameter in case of the first characteristic state (e.g. measured or expected low correlation, etc.), for each channel, a harmonicity measure, or a value derived from the harmonicity measure; and/or as joint parameter in case of the second characteristic state (e.g. measured or expected high correlation, etc.), a common (joint) parameter derived from harmonicity measures computed for the two channel (the joint parameter could be, for example, an average of, or more in general a linear combination between, or a value intermediate between, the harmonicity measure, or of information derived from the harmonicity measure) (examples of harmonicity measures are LTP parameters, e.g. LTP gains and/or cross correlations, e.g. normalized cross correlations, which may be quantized or non-quantized).

It will be shown that in some cases the determiner's decision on the state of the characteristic 642 may be based on the coherence, correlation, covariance, similitude, etc. between the channels (e.g. in the time domain version of the signal 602). However, in some cases, the decision on the state of the characteristic may be based on the immediately preceding frame, e.g. by counting the number of bands for which the M/S conversion has been performed at the stereo processing unit 620, thereby providing the indication of an expectation of the coherence, correlation, covariance, similitude, etc. for the current frame.

Even if not shown in FIG. 6, the parameters (channel-specific parameter(s) and/or joint parameter(s)) taken into account for controlling the signal shaping unit 610 (which may be, for example, harmonicity measures, such LTP parameters, e.g. LTP gains and/or cross correlations, e.g. normalized cross correlations) may be those that are coded in the coded signal 632 (e.g., after quantization) even though not shown in FIG. 6. This will be shown in following figures.

In the examples above and below, it is often shown, for completeness, that the channel-specific parameters in case of the first characteristic state and the joint parameter in case of the second characteristic state are derived from homogeneous metrics (e.g. gain of LTP-filter being used for both the joint parameter and the channel specific parameters, and so on). This is in principle held advantageous, but it is also possible to have that the channel-specific parameters in case of the first characteristic state are taken from channel-specific metrics, while the joint parameter in case of the second characteristic state is derived from homogeneous metrics.

Further, it is possible that the signal 602 is subjected to multiple processings times upstream to the signal shaping unit 610. Therefore, the version for the signal 602 inputted to the signal shaping unit 610 may be in the frequency domain, while the original version of the signal 602 may be in the time domain. Hence, the audio encoder 600 shown in some of the following figures may also comprise a converter from time domain to frequency domain. Further, in some examples the characteristic determiner 640 may base its decision between the first characteristic state and the second characteristic state based on the time domain version of the signal 602. In addition or in alternative, the channel-specific parameter and/or the joint parameter may be obtained from the time domain version of the signal 602. Moreover, in some examples, the signal characteristic 642 may be applied to the frequency domain version of the signal 602.

In any case, the signal 602 (as well as its processed versions 912, 622, etc.) may be, for example, of the type divided into frames (e.g., consecutive frames), according to a particular sequence. E.g. the time length of one frame may be, for example, 20 ms (but different lengths are possible). In the time domain, there are multiple time domain values for each frame, while in the frequency domain, there are multiple bins for each frame. According to some techniques (e.g., modified discrete cosine transform, MDCT, modified discrete sine transform, MDST, etc.) consecutive frames in the sequence can partially overlap with each other.

An example of using the characteristic 642 to control the noise shaping at 610 may be controlling the spectral tilt (for pre-emphasis). The pre-emphasis can have the purpose of increasing the amplitude of the shaped spectrum (612) in the low-frequencies, resulting in reduced quantization noise in the low-frequencies. By using the harmonicity measure (or another analogous parameter) to control the spectral tilt (in the first characteristic state and/or in the second characteristic state), it is possible to control the increase of the amplitude of the shaped spectrum (612) in the low-frequencies in function of the harmonicity of the channel of the signal 602. So, in general terms if a channel of the signal 602 is highly harmonic (e.g. is mostly speech), the amplitude of the shaped spectrum (602) is increased at low frequencies (normally voice), in respect to the high frequencies (mostly noise), whose spectrum's amplitude may be decreased. If a channel is weakly harmonic (e.g. is mostly noise) the lower-frequency part of the spectrum increases for a less extent (or not at all) than in the case of highly harmonic channel, and the higher-frequency part of the spectrum decreases for a less extent (or not at all) than in the case of highly harmonic channel, compared to the higher frequencies. Due to the present techniques, it is possible to cause that: In case of first characteristic state (e.g., low measured or expected similitude, correlation, covariance, coherence etc. between the channels), the spectral tilt is different in the channels, and for each channel the spectral tilt increases or decreases based on a channel-specific parameter (e.g. harmonicity), so that for each channel, a lower harmonicity implies a lower tilt (and a higher harmonicity implies higher tilt).

In case of second characteristic state (e.g., high measured or expected similitude, correlation, covariance, or coherence, etc. between the channels), the same spectral tilt is applied to both the channels, and for all the channels increases or decreases synchronously based on a joint parameter (e.g. average or another intermediate value between the harmonicities of the channels), so that for all the channels, a lower joint parameter implies a lower tilt (and a higher joint parameter implies higher tilt).

An example of a pre-emphasis using a spectral tilt is provided by

$$d ( \frac{b \cdot {g}_{tilt} \cdot {g}_{l , r}^{′}}{h \cdot nb} ) ,$$

where

$$\frac{b \cdot {g}_{tilt} \cdot {g}_{l , r}^{′}}{h \cdot nb}$$

is an exponent applied e.g. to d>1 (e.g. d=10), h>0 (e.g. h≥1, e.g. h=10) is fixed,

$${g}_{l , r}^{′} \geq 0 ( e . g . 0 \leq {g}_{l , r}^{′} \leq 1 )$$

is, or is derived from, the channel-specific parameter, gₜᵢₗₜ>0 is pre-defined and may be, in general, dependent on the sampling frequency (e.g. gₜᵢₗₜ may be higher for higher sampling frequencies), b is an index indicating the band out of nb bands.

A more common notation is

$$1 {0}^{( \frac{b \cdot {g}_{tilt} \cdot {g}_{l , r}^{′}}{h \cdot nb} )} ,$$

which is the same of before but the exponentiation has base 10, as usual. The pre-emphasis is then applied to the spectral energy Eₛ(b), so as to have a pre-emphasized energy information

$${E}_{p} ( b ) = {E}_{s} ( b ) \cdot {d}^{( \frac{b \cdot {g}_{tilt} \cdot {g}_{l , r}^{′}}{h \cdot nb} )} ,$$

or more frequently

$${E}_{p} ( b ) = {E}_{s} ( b ) \cdot {10}^{( \frac{b \cdot {g}_{tilt} \cdot {g}_{l , r}^{′}}{h \cdot nb} )} .$$

It is noted that the spectral energy is in general different between the two channels. Therefore, the notation

$${E}_{p} ( b ) = {E}_{s} ( b ) \cdot {d}^{( \frac{b \cdot {g}_{tilt} \cdot {g}_{l , r}^{′}}{h \cdot nb} )}$$

can be instantiated by

$${E}_{p , l} ( b ) = {E}_{s , l} ( b ) \cdot {d}^{( \frac{b \cdot {g}_{tilt} \cdot {g}_{l}^{′}}{h \cdot nb} )}$$

for a first (e.g. left) channel, and

$${E}_{p , r} ( b ) = {E}_{s , r} ( b ) \cdot {d}^{( \frac{b \cdot {g}_{filt} \cdot {g}_{r}^{′}}{h \cdot nb} )}$$

for the second (e.g. right) channel. Even though the energies per band are different, in the second characteristic state they may be tilted equally.

It is noted that the bands are in general indexed by an index b which may be between a lower index (e.g. 0) to indicate a low frequency (e.g. DC in case of 0) and increases up to a maximum index (e.g. equal to nb, which may be, for example, 63, in the case that the signal is subdivided into 64 bands).

Further, thanks to the present solutions, the spectral tilt also depend on

$${g}_{l , r}^{′} . {g}_{l , r}^{′}$$

may be:

$${g}_{l}^{′} = \{ \begin{matrix}\frac{{g}_{l} + {g}_{r}}{2} , & in case of second characteristic state \\ {g}_{l} , & in case of first characteristic state\end{matrix} \\ {g}_{r}^{′} = \{ \begin{matrix}\frac{{g}_{l} + {g}_{r}}{2} , & in case of second characteristic state \\ {g}_{r} , & in case of first characteristic state\end{matrix}$$

Notably,

$$\frac{{g}_{l} + {g}_{r}}{2}$$

is an example of the joint (common) parameter for the two channels, and is obtained as average of (but could be, in some examples, a linear combination or a value intermediate between) the parameters gₗ (specific of the first, left channel) and gᵣ (specific of the second, right channel). Therefore, once again, in case of second characteristic state (e.g. high correlation . . . ), the same spectral tilt is applied in both channels, i.e. reaching a “tilt synchronization”. In case of first characteristic state (e.g. low correlation . . . ) different spectral tilt values are applied in the channels. Hence, a channel-specific tilt being based on the channel-specific parameter is obtained for each channel. Notably, gₗ (specific of the first, left channel) and gᵣ (specific of the second, right channel) may be, for example, harmonicities and/or parameters obtained from the harmonicity. In examples, the higher the harmonicity, the higher gₗ (specific of the first, left channel) and gᵣ (specific of the second, right channel), the higher the spectral tilt, the higher the quantizing of the lower frequencies of the shaped spectrum with more detail with respect to the higher frequencies. In case of the second characteristic state, an intermediate value (e.g. the average) may be used.

Accordingly, the issues discussed above are mainly overcome: in case of expected transformation to M/S channels for most of the channels, the signals mainly use the same spectral tilt value.

It is noted that often the control of the spectral tilt reduces the spectral tilt with respect to a fixed value, since in the first and second characteristic states a weight between 0 and 1 may be applied (e.g., 0 for a completely noisy or transient channel, and 1 for a totally harmonic channel). This may be obtained, for example, by weighting the tilt using a normalized value, such as a normalized harmonicity. Therefore, each of

$${g}_{l}^{′} and {g}_{r}^{′}$$

may be values between 0 and 1.

Here below there is a non-binding example of how to use the spectral tilt (and more in general the characteristic determiner 640 as well as the characteristic 642) for arriving at the shaped channels of the shaped signal 612. Note that the described steps are applied to all signals in the same way, except for when there is notion of a difference between channels (most notably in step 3). The signal 602 to be shaped has spectrum indicated with X(k) and is held to be in the frequency domain, e.g. MDCT domain (other frequency domains may be used, however), while the shaped signal 622 is indicated with spectral value Xₛ(k) and scale factor g_{SNS}(b), both of which are to be encoded. N_{B}=64 frequency bands are hypothesized (different numbers of bands are possible), indicated by an index b which increases at the increase of the frequency. Each frequency bin is indicated with k and varies among the first bin Ind(b) of the band b to the last bin Ind(b+1)−1 of the band b.

### Step 1: Energy Per Band

Energies per band E_{B}(n) may be computed, for example, as follows (other techniques are possible):

$${E}_{B} ( b ) = {\sum }_{k = Ind ( b )}^{Ind ( b + 1 ) - 1} \frac{{X ( k )}^{2}}{Ind ( b + 1 ) - Ind ( b )} for b = 0 … {N}_{B} - 1$$

with X(k) are the MDCT coefficients, N_{B}=64 is the number of bands and Ind(n) are the band indices. The bands are non-uniform and follow the perceptually-relevant bark scale (smaller in low-frequencies, larger in high-frequencies). E_{B}(n) may be instantiated by E_{B,l}(n) and E_{B,r}(n) for the first and second channels, respectively, and X(k) may be instantiated by Xₗ(k) and Xᵣ(k), respectively.

### Step 2: Smoothing

The energy per band E_{B}(b) may be optionally smoothed using (other techniques are possible):

$${E}_{S} ( b ) = \{ \begin{matrix}0.75 \cdot {E}_{B} ( 0 ) + 0.25 \cdot {E}_{B} ( 1 ) & , if b = 0 \\ 0.25 \cdot {E}_{B} ( 62 ) + 0.75 \cdot {E}_{B} ( 63 ) & , if b = 63 \\ 0.25 \cdot {E}_{B} ( b - 1 ) + 0.5 \cdot {E}_{B} ( b ) + 0.25 \cdot {E}_{B} ( b + 1 ) & , otherwise\end{matrix}$$

Remark: this step is mainly used to smooth the possible instabilities that can appear in the vector E_{B}(b). If not smoothed, these instabilities are amplified when converted to log-domain (see step 5), especially in the valleys where the energy is close to 0. Also in thin case, E_{S}(b) may be instantiated by E_{S,l}(n) and E_{S,r}(n), respectively.

### Step 3: Pre-Emphasis

The smoothed energy per band E_{S}(b) is pre-emphasized using, for the first (e.g. left) channel

$${E}_{p , l} ( b ) = {E}_{s , l} ( b ) \cdot {10}^{\frac{b \cdot {g}_{tilt} \cdot {g}_{l}^{′}}{10 \cdot 63}} for b = 0 … 63$$

and for the second (e.g. right) channel

$${E}_{p , r} ( b ) = {E}_{s , r} ( b ) \cdot {10}^{\frac{b \cdot {g}_{tilt} \cdot {g}_{r}^{′}}{10 \cdot 63}} for b = 0 … 63 \\ with \\ {g}_{l}^{′} = \{ \begin{matrix}\frac{{g}_{l} + {g}_{r}}{2} , & in case of second characteristic state \\ {g}_{l} , & in case of first characteristic state\end{matrix} \\ {g}_{r}^{′} = \{ \begin{matrix}\frac{{g}_{l} + {g}_{r}}{2} , & in case of second characteristic state \\ {g}_{r} , & in case of first characteristic state\end{matrix}$$

(other examples, for defining the joint parameter may be used).

gₜᵢₗₜ may depend on the sampling frequency. gₜᵢₗₜ may be for example 21 at 16 kHz and 26 at 32 kHz (or more in general higher for higher sampling frequencies and lower for lower frequencies).

### Step 4: Noise

An optional noise floor e.g. at −40 dB may be added to E_{P}(b) e.g. using, for each channel,

$${E}_{P} ( b ) = max ( {E}_{P} ( b ) , noiseFloor ) for b = 0 … 63$$

with the noise floor being calculated e.g. by

$$noiseFloor = max ( \frac{{\sum }_{b = 0}^{63} {E}_{P} ( b )}{64} \cdot {10}^{- \frac{40}{10}} , {2}^{- 32} )$$

This may improve quality of signals containing very high spectral dynamics such as e.g. glockenspiel, by limiting the amplitude amplification of the shaped spectrum in the valleys, which has the indirect effect of reducing the quantization noise in the peaks, at the cost of an increase of quantization noise in the valleys where it is anyway not perceptible. E_{P}(b) may be instantiated by E_{P,l}(b) and E_{P,r}(b), respectively.

### Step 5: Logarithm

A transformation into the logarithm domain may be optionally performed using e.g.

$${E}_{L} ( b ) = \frac{{log}_{2} ( {E}_{P} ( b ) )}{2} for b = 0 … 63$$

(other logarithm bases other than 2 may be used, and/or other divisors other than 2 may be used). E_{L}(b) may be instantiated by E_{L,l}(b) and E_{L,r}(b).

### Step 6: Downsampling

The vector E_{L}(b) may be optionally downsampled by a factor of 4 (other factors are possible). E.g. it is possible to use

$${E}_{4} ( b ) = \{ \begin{matrix}w ( 0 ) {E}_{L} ( 0 ) + {\sum }_{k = 1}^{5} w ( k ) {E}_{L} ( 4 b + k - 1 ) & , if b = 0 \\ {\sum }_{k = 0}^{4} w ( k ) {E}_{L} ( 4 b + k - 1 ) + w ( 5 ) {E}_{L} ( 63 ) & , if b = 15 \\ {\sum }_{k = 0}^{5} w ( k ) {E}_{L} ( 4 b + k - 1 ) & , otherwise\end{matrix} \\ with \\ w ( k ) = \{ \frac{1}{12} , \frac{2}{12} , \frac{3}{12} , \frac{3}{12} , \frac{2}{12} , \frac{1}{12} \} .$$

This step may be understood as applying a low-pass filter (w(k)) on the vector E_{L}(b) before decimation. This low-pass filter has a similar effect as the spreading function used in psychoacoustic models: it reduces the quantization noise at the peaks, at the cost of an increase of quantization noise around the peaks where it is anyway perceptually masked. E₄(b) may be instantiated by E_{4,l}(b) and E_{4,r}(b), respectively.

### Step 7: Mean Removal and Scaling

The final scale factors are obtained after mean removal and scaling by a factor of 0.85

$$scf ( n ) = 0.85 ( {E}_{4} ( n ) - \frac{{\sum }_{b = 0}^{15} {E}_{4} ( b )}{16} ) for n = 0 … 15$$

Since the codec has an additional global-gain, the mean can be removed without any loss of information. Removing the mean also allows more efficient vector quantization.

The scaling of 0.85 slightly compress the amplitude of the noise shaping curve. It has a similar perceptual effect as the spreading function mentioned in Step 6: reduced quantization noise at the peaks and increased quantization noise in the valleys. scf(n) may be instantiated by scfₗ(n) and scfᵣ(n), respectively.

### Step 8: Quantization

The scale factors may be quantized using vector quantization, producing indices which are then packed into the bitstream and sent to the decoder, and quantized scale factors scfQ(n).

### Step 9: Interpolation

The quantized scale factors scfQ(n) may be interpolated e.g. using

$$scfQint ( 1 ) = scfQ ( 0 )$$

$$scfQint ( 1 ) = scfQ ( 0 )$$

$$scfQint ( 4 n + 2 ) = scfQ ( n ) + \frac{1}{8} ( scfQ ( n + 1 ) - scfQ ( n ) ) for n = 0 … 14$$

$$scfQint ( 4 n + 3 ) = scfQ ( n ) + \frac{3}{8} ( scfQ ( n + 1 ) - scfQ ( n ) ) for n = 0 … 14$$

$$scfQint ( 4 n + 4 ) = scfQ ( n ) + \frac{5}{8} ( scfQ ( n + 1 ) - scfQ ( n ) ) for n = 0 … 14$$

$$scfQint ( 4 n + 5 ) = scfQ ( n ) + \frac{7}{8} ( scfQ ( n + 1 ) - scfQ ( n ) ) for n = 0 … 14$$

$$scfQint ( 62 ) = scfQ ( 15 ) + \frac{1}{8} ( scfQ ( 15 ) - scfQ ( 14 ) )$$

$$scfQint ( 63 ) = scfQ ( 15 ) + \frac{3}{8} ( scfQ ( 15 ) - scfQ ( 14 ) )$$

and transformed back into linear domain using

$${g}_{SNS} ( b ) = {2}^{scfQint ( b )} for b = 0 … 63$$

Interpolation is used to get a smooth noise shaping curve and thus to avoid any big amplitude jumps between adjacent bands. Also g_{SNS}(b) may be instantiated by g_{SNS,l}(b) and g_{SNS,r}(b), respectively.

### Step 10: Spectral Shaping

SNS scale factors g_{SNS}(b) are applied on the MDCT frequency lines for each band separately in order to generate the shaped spectrum Xₛ(k)

$${X}_{s} ( k ) = \frac{X ( k )}{{g}_{SNS} ( b )} for k = Ind ( b ) … Ind ( b + 1 ) - 1 , for b = 0 … 63$$

Xₛ(k) may be instantiated by X_{s,l}(k) and X_{s,r}(k), respectively. The calculation of the scale factors g_{SNS}(b) to be used for shaping the signal 602 and obtaining the shaped channels 612 may be therefore controlled by a spectral tilt value. It is noted that a comparatively higher spectral tilt results in quantizing the lower frequencies of the shaped spectrum with more detail while a comparatively lower spectral tilt results in quantizing the spectrum more equally over the whole spectral range. The pre-emphasis applied by the signal shaping unit 610 may increase the amplitude of the shaped spectrum (622) in the low frequencies, resulting in reduced quantization noise in the low-frequencies. Using the channel-specific parameter(s) and/or joint parameter(s) (e.g. harmonicity measures) to control the spectral tilt permits to adapt the strength of this effect to the channel-specific parameter(s) and/or joint parameter(s) (e.g. harmonicity measures) of the audio signal 602. So, for highly-harmonic signals, the effect is increasing the amplitude of the shaped spectrum 622 at low frequencies, so that there is reduced quantization noise, and for non-harmonic signals there is applied a less strong spectral tilt on the shaped energies (the lower-frequency part of the spectrum is not amplified too much or not at all compared to the higher frequencies), hence permitting to quantize more evenly over the whole spectrum.

It is to be noted that different techniques for defining the spectral tilt based on the characteristic 642 may be chosen. Any of steps 1, 2, and 4-10 may be avoided, in some cases.

Even more in general, it is not necessary to define the spectral tilt as in step 3. In some examples, in the first characteristic state the value of the spectral tilt may be independent from the harmonicity (or more in general from the channel-specific parameter), while in the second characteristic state the value of the spectral tilt may be dependent on the harmonicity (or more in general on the joint parameter). In other cases, in the first characteristic state the value of the spectral tilt may be dependent on the harmonicity (or more in general on the channel-specific parameter), while in the second characteristic state the value of the spectral tilt may be independent from the harmonicity (or more in general from the joint parameter). In other examples, both in the first and in the second characteristic the tilt value may be independent from the harmonicity. In many examples, the tilt is higher in the second characteristic state than in the first characteristic state.

FIGS. 3-5 show particular examples of FIG. 6.

FIG. 3 shows an example of encoder 300 which may be a particular instantiation of the encoder 600 of FIG. 6. Here, there is shown that an audio signal 302 (in this case being a time domain version of the signal 602) is subjected to signal shaping at stage 310 (which may be an example of the signal shaping unit 610) for each of the channels. The channels l and r are here both subjected to an LTP at LTP stage 315 and, subsequently, are converted into a frequency domain (in this case it is shown that the domain is the MDCT domain) at stage 323, to be indicated with L and R, thereby obtaining a frequency domain version 304 of the signal 302 (signal 602 may be instantiated by any or of both of the versions 302 and 304). The signal noise shaping at stage 310 (instantiating 610 of FIG. 6) is based on the LTP gains obtained in LTP stage 315. Notably, however, if the channels L and R are highly correlated (e.g. highly covariant, or highly similar), then the characteristic determiner 340 (which may be an instantiation of block 640 in FIG. 6) selects the second characteristic state. Accordingly, the audio signal may be shaped using the same spectral tilt for the two channels in case the channels are (or are expected to be) similar to each other. Otherwise, different spectral tilts are used for the different channels, e.g. using gₗ for channel L and gᵣ for channel R at the signal shaping at stage 310 (610). A stereo processing unit 320 (which may be an instantiation of the stereo processing unit 620 of FIG. 6) may perform a band-wise stereo decision and, where decided, may perform a conversion into joint channels of signal 622 (otherwise, the spatial channels L and R are maintained). The characteristic determiner 340 (640), in this case, may receive or measure a metric 624 on how many bands have been converted into the mid-side domain in the previous frame. The characteristic determiner (tilt synchronization stage) 340 (640) may determine the characteristic based on the number of bands which, for immediately preceding frame (or for a number of preceding frames) has been converted into the mid/side domain. The arrow 624 providing the information num_MSbands is therefore provided to the characteristic determiner 340. The symbol 624′ is for indicating the frame delay. The characteristic determiner 340 therefore decides whether to cause the same spectral tilt to the different channels at the signal shaping block 310 or not based on whether num_MSbands exceeds a threshold. For example, if more than 80% (or another threshold, e.g. between 70% and 90, or more than 50%) of the bands have been converted into mid/side domain in the immediately previous frame (e.g. num_MSbands>80%), then the same spectral tilt will be used by the signal shaper 310 for both the channels. Otherwise, (e.g. num_MSbands<80%) different spectral tilts are used for the different channels. In the examples in which the frames are subdivided into subframes (e.g., in case of block-switching) it is possible to either calculate an average between the subframes, or considering only the last subframe.

In alternatives, the provision of the information 624 may be avoided and, in that case, the characteristic determiner 640 may decide based, for example, on measurements of the similitude between the different channels (e.g., covariance, correlation, coherence, similitude, and so on), e.g. as taken from the time domain version of the signal 302.

FIG. 4 shows an example 400 which may be an instantiation of the encoder 600 above. Here, an input audio signal 402 may be converted into a frequency domain representation (channels L and R) 403 at stage 423. The representations 402 and 403 of the audio signals may be seen as corresponding to the versions 302 and 304, respectively, and instantiate the audio signal 602 of FIG. 6. LTP parameter stage 415 (which may be an instantiation of the LTP parameter calculation 315 of FIG. 3) is also provided in the time domain. Hence, LTP parameters gₗ and gᵣ may be quantized (indicated as 371) at parameter quantizer stage 370 and then inserted in the bitstream (including the coded signal 432, 632) by the encoded signal coder 430 (which may be an embodiment of the coded signal writer 630). Here, a characteristic determiner (tilt synchronization stage) 440 (which may be an embodiment of the characteristic determiner 640 and 340) may be used for determining whether the characteristic is in the first characteristic state or in the second characteristic state. Similar to the example of FIG. 3 an information of the number of the bands for which the preceding frame (e.g., immediately preceding frame) has been converted into mid/side domain is provided as 424 (and through the delay 424′). Even in this case, a signal shaping unit 410 (which may embody this signal shaping unit 610) is also provided for providing shaped channels L′ and R′ (shaped signal 412) by providing the parameters

$${g}_{l}^{′} and {g}_{r}^{′}$$

obtained from the LTP stage 415. For the rest, stereo processing 420 (which may embody the stereo processing 620) operates the same way, providing joint channels 422 (622) in the signal 422 (622). Here, an IGF and quantization and entropy coding stage 450 is provided so that the resulting signal 452 is provided to the coded signal writer 430 (630).

While in FIG. 4 the channel-specific parameter and/or the joint parameter are provided in the unquantized version, it is also possible to provide the

$${g}_{l}^{′} and {g}_{r}^{′}$$

in quantized version (e.g. in the version 371 which is provided to the bitstream writer 430).

FIG. 5 shows another example 500 which may also be an embodiment of the example 600 of FIG. 6 and/or of the example 400 of FIG. 4 or 300 of FIG. 3. Here, the same reference numerals are used of the example of FIG. 4, apart from where it is needed to find some differences. In particular, in this case, the characteristic determiner (tilt synchronization stage) 540 (instantiating the characteristic determiner 640 of FIG. 6 and/or 430 of FIG. 4) does not base the decision or whether causing the same spectral tilt or not to the signal shaping unit 410 based on the number of bands for which the conversion into mid-side channels is performed. Here, the characteristic determiner 540 based on a measurement 524 (also indicated with c) which may be, for example, an inter-channel correlation, c, (e.g. obtained from a correlation computation unit 525) between the channels l and r (in this case, e.g., in the time domain). For example, it is possible to state:

$${g}_{l}^{′} = \{ \begin{matrix}\frac{{g}_{l} + {g}_{r}}{2} , & if c < α ( second characeristic state ) \\ {g}_{l} , & otherwise ( first characeristic state )\end{matrix}$$

$${g}_{r}^{′} = \{ \begin{matrix}\frac{{g}_{l} + {g}_{r}}{2} , & if c > α ( second characeristic state ) \\ {g}_{r} , & otherwise ( first characeristic state )\end{matrix}$$

As explained above, however, an linear combination instead of the average maybe be used, or a value intermediate between gl and gr. The inter-channel correlation, c, may be normalized e.g., to be in the range [0, 1.0]. α may be a threshold value for the correlation measure above which mainly M/S coding is expected to be chosen in the later stereo processing. α can be e.g. 0.8 (or a value between 0.7 and 0.9, for example). The inter-channel correlation, c, may be obtained, for example, from the time domain version 102 of the audio signal.

In some examples, the joint parameter could be computed as g_joint=a*gₗ+b*gᵣ, with a+b=1, a>0, b>0. a and b can be determined, for example, based on the energies of the channels (e.g. the higher the energy of the first channel in respect to the energy of the second channel, the higher a, and the higher the energy of the second channel in respect to the energy of the first channel, the higher b), so that the spectral tilt of the channel with the higher energy has more weight in the joint parameter value. Therefore, a and b are proportional to the energy of their channel, respectively. Coefficients a and b therefore partition the channel-specific parameter according to the energy of each channel.

Thanks to the invention a result is achieved in that, in highly correlated channels, the use of different spectral tilts may be avoided. This may sound counter-intuitive, as adapting the spectral tilt to the harmonicity of the respective channel in general helps to adapt the quantization step size over the spectral range to the signal characteristic. For coding only one (mono) signal this in general holds. However, the inventors have taken into account that, when coding more than one (stereo) signals in a joint fashion, there is also the joint coding to consider. Highly correlated signals can be efficiently coded in (mainly) M/S representation, which achieves good perceptual quality for this kind of signals. However, coding the signal in M/S representation inserts correlated quantization noise into the final decoded signal. Using differently pre-emphasized FDNS parameters, i.e. ones that were calculated used a different spectral tilt, for the input channels results in different spectral shaping of both the decoded channels and the inserted quantization noise (which for M/S coded bands is the same in both decoded channels) when decoding the signals. This can lead to spatial unmasking of the quantization noise which reduces perceptual quality greatly and is therefore undesirable. In contrast, with the invention, using FDNS parameters which are less optimally pre-emphasized for the respective channels is outweighed by the quality increase that the joint channel coding achieves for such signals. So, even if the tilt synchronization decision is applied for all bands, the benefit of a synchronized tilt in the jointly coded bands is bigger than the potentially sub-optimal tilt used in the non-jointly coded bands—especially if the synchronized (same) tilt is only used when it is expected that the majority of the bands is coded jointly. Synchronizing the (having the same) spectral tilt for correlated channels also allows for efficient joint coding of not only the signals, but also the SNS parameters themselves (using, e.g. [5]), thus decreasing the bit demand for transmission of the SNS parameters. One could assume that for highly correlated signals also the calculated noise shapes would be similar enough anyway to not need synchronization. However, the inventors have understood that influences such as signal fluctuations due to background noise or general imperfections of signal analysis algorithms are still capable of causing differences in the spectral tilts applied.

Another advantage is a complexity benefit over the possible alternative of producing two sets of shaped channels (one with individual tilts and one with joint tilt) and in the later stereo processing using the ones with individual tilt for the L/R coded bands and using the ones with joint tilt in the M/S coded bands. This would involve to perform two whitening operations in the encoder. Another drawback of this alternative would be that two sets of FDNS parameters would need to be transmitted to the decoder for decoding both the L/R coded signal parts and the M/S coded signal parts.

### Discussion

This invention permits, inter alia, to adaptively sync (e.g. using the same) spectral tilt between different channels to achieve a balance between using as-accurate-as-possible parameters for individual-channel coding tools and achieving good channel compaction in the stereo processing.

Here below some embodiments of the above-presented examples (e.g. those of FIGS. 3-5) are discussed. In order to simplify the reading, some less general hypotheses are made, despite being generalizable as above.

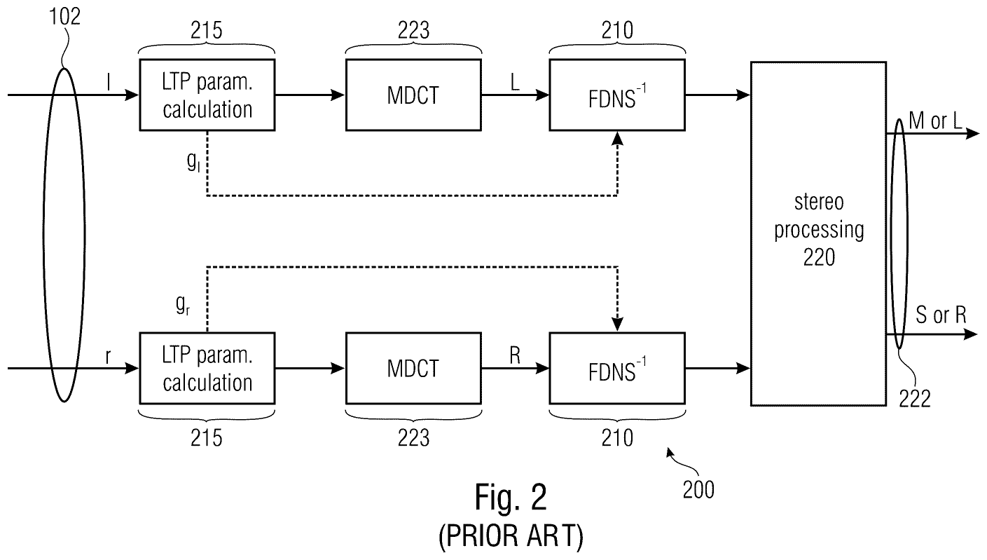

FIG. 3 shows an example of the present techniques, which may be an embodiment of FIG. 6. Here, the unquantized LTP filter gains gₗ and gᵣ are not directly applied in the calculation of the SNS tilt, but they can be synchronized, i.e. set to the same value for both channels. The decision whether to use the individual channel's filter gains for computing the SNS parameters or using the same value is based on the number of bands that are coded in M/S representation in the previous frame (denoted as n). As an example, if the number of M/S-bands in the previous frame is above an experimentally adjusted threshold, the spectral tilt in both channels is multiplied by the average of the two ltp filter gains instead of using gₗ for the left channel and gᵣ for the right channel, respectively. Otherwise, each channel's spectral tilt is multiplied by the respective channel's ltp filter gain as in FIG. 2.

This approach can prevent stereo unmasking artifacts that can occur when correlation is high between the two channels (and thus M/S coding is used in most or all bands) and at the same time the harmonicity measures differ between the channels resulting in different spectral tilts. Differences in the harmonicity measures can occur due to signal fluctuations, background noise and imperfections of the estimation algorithms and can probably not be avoided completely. Obvious solutions for this case would be to force L/R coding or to use the same spectral tilt for both channels. Forcing L/R coding would be suboptimal in the stereo decision sense as even though harmonicity measures—and thus spectral tilts and the scale factors used in whitening the signal—are different, the problematic signal portions are still correlated and M/S coding achieves far better perceptual quality there. Using the same spectral tilt in both channels can also be suboptimal in the perceptual noise shaping sense since adapting the spectral tilt to the harmonicity of the signal in general leads to less audible quantization noise. Thus, the adaptive synchronization mechanism helps to use an optimal spectral tilt for the individual channels in general and only trade off a potentially less optimal spectral tilt for avoiding stereo unmasking artifacts when inter-channel correlation is high. Using the previous frame's number of M/S-coded bands as the decision criterion is computationally cheap and makes use of the existing coder architecture. The invention can thus be easily added to the stereo coder without greatly increasing computational complexity or imposing structural changes to the overall system.

FIG. 4 shows integration of the invention into the MDCT-Stereo framework. The left and right input channels of the input signal 402 in time domain are denoted as l and r, respectively, and are processed in blocks (frames). The input signals 402 are transformed (to obtain signal 403) to the frequency domain, e.g. using the MDCT at stage 423, and pre-processed, e.g. with TNS (also indicated in stage 423). Different time-to-frequency transforms or pre-processing methods (along or without TNS) can be applied.

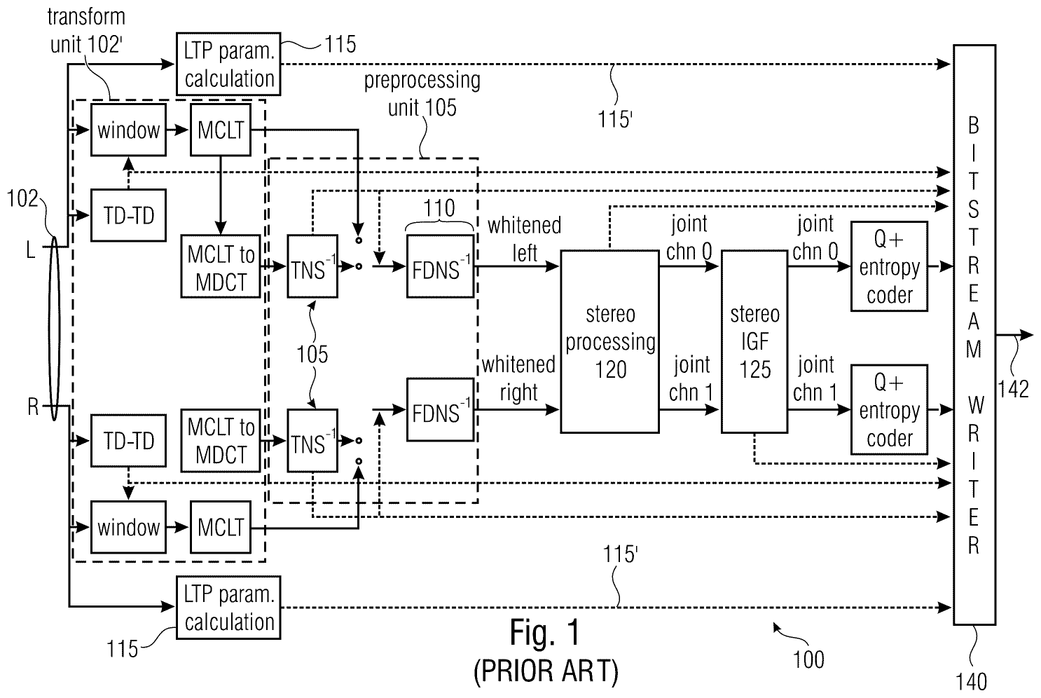

The LTP parameter calculation block 315 may be same as block 115 in FIG. 1 and/or functionally equivalent to what is described in [2], except that (in examples) the output gain values gₗ and gᵣ are not quantized and are normalized to the range [0, 1.0]. Quantization of the gains is denoted by the downstream Q blocks and may be the same as applied in [2]. The unquantized gains are processed by the Tilt Synchronization Stage (characteristic determiner) 440 (640) to generate the current frame's spectral tilt values to be used in FDNS, gl′ and gr′ may be as

$${g}_{l}^{′} = \{ \begin{matrix}\frac{{g}_{l} + {g}_{r}}{2} , & if n > β ( second characeristic state ) \\ {g}_{l} , & otherwise ( first characeristic state )\end{matrix}$$

$${g}_{r}^{′} = \{ \begin{matrix}\frac{{g}_{l} + {g}_{r}}{2} , & if n > β ( second characeristic state ) \\ {g}_{r} , & otherwise ( first characeristic state )\end{matrix}$$

$$n = ( 1 - \frac{{n}_{MS}}{{n}_{bands}} ) ,$$

where nMS is the number of M/S-coded bands for the previous frame as determined in the stereo processing block (as described in [1]), nbands is the total number of frequency bands used in the stereo processing and β is a threshold value below which mainly M/S coding is expected to be chosen in the later stereo processing. β can be e.g. 0.2. If the current frame is further divided into subframes (e.g. by using block-switching), then n is calculated for each subframe individually and the average is used. Alternatively, instead of using the average n over all subframe, the value obtained for n in the last subframe only can be used. As no previous frame is available at the beginning of the signal, n is set to 1 in the first frame.

The transformed and pre-processed signals are fed into the FDNS⁻¹ blocks to generate the whitened signals L′ and R′, respectively. Here, FDNS is implemented using SNS[3] with an adaptive spectral tilt[4]. The spectral tilt is changed by multiplying the constant tilt value with the respective output of the Tilt Synchronization Stage. So, Step 3 of [3, page15] is modified to

$${E}_{p , l} ( b ) = {E}_{s , l} ( b ) \cdot {10}^{\frac{b \cdot {g}_{tilt} \cdot {g}_{l}^{′}}{10 \cdot 63}} for b = 0 … 63$$

for the left channel and

$${E}_{p , r} ( b ) = {E}_{s , r} ( b ) \cdot {10}^{\frac{b \cdot {g}_{tilt} \cdot {g}_{r}^{′}}{10 \cdot 63}} for b = 0 … 63$$

for the right channel, respectively. The fixed values for gtilt depend on the sampling rate and are for example 21 at 16 kHz and 26 at 32 kHz.

The whitened signals L′ and R′, respectively, are then stereo-processed as described in [1] to generate two joint channels. Afterwards, Bandwidth Extension (BWE) encoding, e.g. using IGF, quantization and entropy coding, e.g. using a range coder) are applied on the join channels. Finally, all quantized parameters are written to a bitstream for transmission or storage.

Alternatively, the maximum of the normalized auto-correlation for the found pitch in the LTP param. calculation (as described in [2]) can be used as a replacement for the unquantized LTP gain values. In that case, gl and gr are set to the maximum autocorrelation value for the respectively channel. The remaining processing stays the same.

A possible variant is shown in FIG. 5. Similar named blocks are the same as in FIG. 4, except for the following changes. The condition for setting the spectral tilt to the same value in the Tilt Synchronization Stage does not use the number of M/S-coded bands as in FIG. 4. Instead, a measure of the inter-channel correlation, c, is calculated for the stereo channels. This can be computed in time domain as e.g. the cross-correlation coefficient of the two channels or in the frequency domain using e.g. a cross-coherence measure. The output of the Tilt Synchronization stage is then

$${g}_{l}^{′} = \{ \begin{matrix}\frac{{g}_{l} + {g}_{r}}{2} , & if c < α \\ {g}_{l} , & otherwise\end{matrix}$$

$${g}_{r}^{′} = \{ \begin{matrix}\frac{{g}_{l} + {g}_{r}}{2} , & if c < α \\ {g}_{r} , & otherwise\end{matrix}$$

where c is normalized to be in the range [0, 1.0] and α is a threshold value for the correlation measure above which mainly M/S coding is expected to be chosen in the later stereo processing. α can be e.g. 0.8.

### Important Aspects

Important aspects are here below summarized.

The present techniques include applying band-wise M/S decision in the whitened frequency spectrum domain, with whitening process being controlled by a signal-adaptive parameter, configured to adaptively decide whether to apply the individual channel parameters during whitening or to calculate and use a common parameter value instead.

The present techniques include applying band-wise M/S decision in the whitened frequency spectrum domain, with whitening process being controlled by a signal-adaptive parameter, parameter being a harmonicity that that is larger for harmonic signals and smaller for non-harmonic signals.

Alternatives: parameter being the maximum normalized auto-correlation value for the pitch value determined in the LPT gain calculation; parameters being LPT gains

The present techniques include applying band-wise M/S decision in the whitened frequency spectrum domain, with whitening process being controlled by a signal-adaptive parameter, configured to adaptively decide whether to apply the individual channel parameters during whitening or to calculate and use a common parameter value, where decision is based on the previous frame's number of M/S coded bands.

The present techniques include applying band-wise M/S decision in the whitened frequency spectrum domain, with whitening process being controlled by a signal-adaptive parameter, configured to adaptively decide whether to apply the individual channel parameters during whitening or to calculate and use a common parameter value, where decision is based on the inter-channel correlation measure.

The present techniques include applying band-wise M/S decision in the whitened frequency spectrum domain, with whitening process being controlled by a signal-adaptive parameter, configured to adaptively decide whether to apply the individual channel parameters during whitening or to calculate and use a common parameter value, where decision is based on the inter-channel coherence measure.

It is to be noted that the scaling of the spectral (pre-emphasize) tilt slightly increases the computational effort, since a scaling by

$${g}_{l}^{′} and / or {g}_{r}^{′}$$

is carried out, for example. However, when calculating

$${E}_{p , l} ( b ) = {E}_{s , l} ( b ) \cdot {d}^{\frac{b \cdot {g}_{tilt} \cdot {g}_{l}^{′}}{h \cdot nb}} for b = 0 … nb and {E}_{p , r} ( b ) = {E}_{s , r} ( b ) .$$

$${d}^{\frac{b \cdot {g}_{tilt} \cdot {g}_{r}^{′}}{h \cdot nb}} for b = 0 … nb ,$$

it is possible to calculate the exponent

$$\frac{b \cdot {g}_{tilt} \cdot {g}_{l}^{′}}{h \cdot nb} and \frac{b \cdot {g}_{tilt} \cdot {g}_{r}^{′}}{h \cdot nb}$$

by
First, calculating the term

$$\frac{{g}_{tilt}}{h \cdot nb}$$

(common for both channel and all bands);
Second, commonly to all the bands (or at least to a plurality of evaluated bands), but for each channel, scaling the common term

$$\frac{{g}_{tilt}}{h \cdot nb}$$

by

$${g}_{l}^{′}$$

and by

$${g}_{r}^{l} ,$$

respectively;
Third, for each band and each channel, scaling the obtained term

$$\frac{{g}_{tilt} {g}_{l}^{′}}{h \cdot nb}$$

by the band index b, to thereby obtain the exponent.

More in general, it is possible to calculate the pre-emphasize tilt for the first and second

channels by, for each band: first, calculating a common term, common to both channel (e.g. based on the sampling frequency); then: in case of first characteristic state, for each channel, scaling the common term by the channel-specific parameter; in case of second characteristic state, for both channels, scaling the common term by the joint parameter.

The term b associated to each band may be multiplied either before or after the scaling by the channel-specific parameter (respectively, joint parameter).

The term nb may also be applied at the end, together with b, as n/nb.

Therefore, the computational effort added by the adaptive spectral tilt is low, such maintaining the overall low complexity of the spectral noise shaping technique.

### Further Implementations

Depending on certain implementation requirements, examples may be implemented in hardware. The implementation may be performed using a digital storage medium, for example a floppy disk, a Digital Versatile Disc (DVD), a Blu-Ray Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a flash memory, having electronically readable control signals stored thereon, which cooperate (or are capable of cooperating) with a programmable computer system such that the respective method is performed. Therefore, the digital storage medium may be computer readable.

Generally, examples may be implemented as a computer program product with program instructions, the program instructions being operative for performing one of the methods when the computer program product runs on a computer. The program instructions may for example be stored on a machine readable medium.

Other examples comprise the computer program for performing one of the methods described herein, stored on a machine readable carrier. In other words, an example of method is, therefore, a computer program having a program instructions for performing one of the methods described herein, when the computer program runs on a computer.

A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory.

A further example comprises a processing unit, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] G. Markovic, E. Ravelli, M. Schnell, S. Döhla, W. Jägers, M. Dietz, C. Helmrich, E. Fotopoulou, M. Multrus, S. Bayer, G. Fuchs und J. Herre, “APPARATUS AND METHOD FOR MDCT M/S STEREO WITH GLOBAL ILD WITH IMPROVED MID/SIDE DECISION”. WO-Patent WO2017EP51177, 20. 01. 2017.
[2] 3GPP TS 26.445, Codec for Enhanced Voice Services (EVS); Detailed algorithmic description.
[3] E. Ravelli, M. Schnell, C. Benndorf, M. Lutzky und M. Dietz, “Apparatus and method for encoding and decoding an audio signal using downsampling or interpolation of scale parameters”. WO-Patent WO 2019091904 A1, 5. 11. 2018.
[4] Markovic, Goran. Transform-based Coding Methods for Speech and other Audio Signals. Diss. Friedrich-Alexander-Universität Erlangen-Nürnberg (FAU), 2022.
[5] E. Fotopoulou, F. Reutelhuber, G. Markovic, J. Kiene, S. Döhla, “Audio Decoder, Audio Encoder, and Related Methods Using Joint Coding of Scale Parameters for Channels of a Multi-Channel Audio Signal”, European Patent EP20184555.9.

1. An audio encoder for encoding a multichannel audio signal into a coded signal, the multichannel audio signal comprising a plurality of channels comprising a first channel and a second channel, the audio encoder comprising:
a signal shaping unit configured to shape each channel of the plurality of channels using one or more scale parameters to obtain shaped channels, the signal shaping unit being configured to derive, for each channel of the plurality of channels, of the one or more scale parameters;
a stereo processing unit configured to receive the shaped channels and to provide a joint shaped audio signal from the shaped channels,
a coded signal writer, configured to form a coded signal with at least the joint shaped audio signal; and
a characteristic determiner configured to determine a characteristic from the plurality of channels comprising a characteristic state selected between at least one first characteristic state and one second characteristic state, the first characteristic state being different from the second characteristic state,
wherein the signal shaping unit is configured to be controlled by the characteristic determiner and to derive:
in the first characteristic state, for each channel of the plurality of channels, the one or more scale parameters using a channel-specific parameter for the channel; and
in the second characteristic state, for each channel of the plurality of channels, the one or more scale parameters using a joint parameter derived from the first channel and the second channel.

2. The audio encoder of claim 1, wherein the signal shaping unit is configured to use, as the channel-specific parameter, a harmonicity measure for the specific channel or a measure derived from the harmonicity measure, and/or
derive the joint parameter from harmonicity measures of the channels.

3. The audio encoder of claim 1, wherein the signal shaping unit is configured to use, as the channel-specific parameter, a LTP parameter of the channel or a measure derived from the LTP parameter, and/or
derive the joint parameter from long term prediction, LTP, parameters of the channels.

4. The audio encoder of claim 1, wherein the signal shaping unit is configured to use, as the channel-specific parameter, a quantized channel-specific parameter or respectively normalized channel-specific parameter, or a measure derived from the quantized channel-specific parameter or respectively normalized channel-specific parameter and/or
derive the joint parameter from a quantized channel-specific parameter or respectively normalized channel-specific parameter.

5. The audio encoder of claim 1, wherein the signal shaping unit is configured to use, as the channel-specific parameter, a spectral flatness measure computed for the respective channel, or a measure derived from the spectral flatness measure computed for the respective channel, and/or
derive the joint parameter from spectral flatness measures computed for the channels.

6. The audio encoder of claim 1, wherein in the first characteristic state the signal shaping unit is configured to apply, for each channel, the channel-specific parameter to control a pre-emphasize tilt applied to channel-specific energy(ies) per band, to thereby derive pre-emphasized channel specific energy(ies) per band from which the one or more scale parameters are derived, and/or
in the second characteristic state the signal shaping unit is configured to apply the joint parameter to all the channels, to control the pre-emphasize tilt applied to channel-specific energy(ies) per band, to thereby derive pre-emphasized channel-specific energy(ies) per band from which the one or more scale parameters are derived.

7. The audio encoder of claim 6, configured to calculate the pre-emphasize tilt for the first and second channels by, for each band:
first, calculating a common term, common to both channel;
then:
in case of first characteristic state, for each channel scaling the common term by the channel-specific parameter; and
in case of second characteristic state, for both channels scaling the common term by the joint parameter.

8. The audio encoder of claim 1, configured so that a comparatively higher channel-specific parameter causes a higher pre-emphasize tilt to be applied to the channel specific energy(ies) per band, than a comparatively lower channel-specific parameter, and/or
a comparatively higher joint parameter causes a higher pre-emphasize tilt to be applied to the channel specific energy(ies) per band, than a comparatively lower joint parameter.

9. The audio encoder of claim 1, wherein the channel-specific parameter is the same for all, or a plurality of, the bands of the same channel, and/or
the joint parameter is the same for all, or a plurality of, the bands of the same channel.

10. The audio encoder of claim 1, configured to use the joint parameter as, or as defined based on, an average, or at least on an intermediate value, between channel-specific parameters of the channels.

11. The audio encoder of claim 1, configured to use the joint parameter as, or as defined based on, an integral value, or an information on the integral value, between specific parameters of the channels, or values indicative of the channel-specific parameters of the channels, or values derived from the specific parameters of the channels.

12. The audio encoder of claim 1, configured to use the joint parameter by weighting the specific parameters of the channels by applying a first weight to the channel-specific parameter of the first channel and a second weight to the channel-specific parameter of the second channel, the first and second weights being proportional to the energy of the first and second channel, respectively.

13. The audio encoder of claim 1, configured to use the characteristic as, or as determined from, a coherence, correlation or covariance between the plurality of channels, wherein comparatively higher coherence, correlation or covariance values cause the characteristic to be in the second characteristic state, and comparatively lower coherence, correlation or covariance values cause the characteristic to be in the first characteristic state.

14. The audio encoder of claim 1, configured to use the characteristic as, or as determined from, a similitude degree between the plurality of channels, wherein comparatively higher similitude values cause the characteristic to be in the second characteristic state, and comparatively lower similitude values cause the characteristic to be in the first characteristic state.

15. The audio encoder of claim 1, wherein the stereo processing unit is configured to decide band-wise between:
converting the plurality of shaped channels onto a mid channel and a side channel, the mid channel and the side channel thereby constituting the joint channels; and
defining the joint channels as the plurality of shaped channels.

16. The audio encoder of claim 15, wherein the stereo processing unit is configured to decide between converting the shaped audio signal from the plurality of shaped channels onto a mid channel and a side channel and defining the joint channels as the plurality of channels based, at least in part, on a minimization of bitrate demand.

17. The audio encoder of claim 1, wherein the signal shaping unit is configured to spectrally tilt the audio signal according to shaping parameters obtained by applying, for each channel, a pre-emphasize tilt to energy(ies) of band(s) in reason of channel-specific parameters, wherein the channel-specific parameters are channel specific for the plurality of channels in the first characteristic state, and equal in the second characteristic state.

18. The audio encoder of claim 1, wherein the characteristic is indicative of a degree of similarity between the plurality of channels.

19. The audio encoder of claim 1, configured to apply the channel-specific parameter as a parameter which is 1, or another constant value B>0, in case of a channel being totally harmonic, and 0 in case of a channel being totally non-harmonic, and
configured to apply the joint parameter as a parameter which is an average and/or integral value, and/or an intermediate value between two channel-specific parameters, each of the two channel-specific parameters being 1, or another constant value B>0, in case of the channel being totally harmonic, and 0 in case of the channel being totally non-harmonic.

20. A non-transitory storage unit storing instructions which, when executed by a processor, cause the processor to perform a method for encoding a multichannel audio signal into a coded signal, the multichannel audio signal comprising a plurality of channels comprising a first channel and a second channel, the method comprising:
shaping each channel of the plurality of channels using one or more scale parameters to obtain shaped channels, the shaping comprising deriving, for each channel of the plurality of channels, the one or more scale parameters;
performing a stereo processing, the stereo processing comprising providing a joint shaped audio signal from the shaped channels,
forming a coded signal with at least the joint shaped audio signal; and
determining a characteristic from the plurality of channels comprising at least one of a first characteristic state and a second characteristic state, the first characteristic state being different from the second characteristic state,
wherein the shaping is controlled by the characteristic to derive:
in the first characteristic state, for each channel of the plurality of channels, the one or more scale parameters using a channel-specific parameter for the channel; and
in the second characteristic state, for each channel of the plurality of channels, the one or more scale parameters using a joint parameter derived from the first channel and the second channel.
